(19) United States
(12) Patent Application Publication
(10) Pub. No.: US 2023/0125529 A1
(43) Pub. Date: Apr. 27, 2023

(54) POINT CLOUD DECODING DEVICE, POINT CLOUD DECODING METHOD, AND PROGRAM

(71) Applicant: KDDI CORPORATION, Tokyo (JP)

(72) Inventors: Ryosuke WATANABE, Fujimino-shi (JP); Kyohei UNNO, Fujimino-shi (JP); Kei KAWAMURA, Fujimino-shi (JP)

(73) Assignee: KDDI CORPORATION, Tokyo (JP)

(21) Appl. No.: 18/145,589

(22) Filed: Dec. 22, 2022

Related U.S. Application Data
(63) Continuation of application No. PCT/JP2021/019523, filed on May 24, 2021.

(30) Foreign Application Priority Data
Jun. 22, 2020 (JP) 2020-107205

(51) Int. Cl. G06T 9/00; G06T 9/40

(52) U.S. Cl. CPC G06T 9/001; G06T 9/40

(57) ABSTRACT

A point cloud decoding device includes: a geometry information decoding unit configured to decode numbers of points of respective layers of an octree structure.

### CROSS-REFERENCE TO RELATED APPLICATIONS

The present application is a continuation based on PCT Application No. PCT/JP2021/019523, filed on May 24, 2021, which claims the benefit of Japanese patent application No. 2020-107205, filed on Jun. 22, 2020. The content of all of which are incorporated by reference herein in their entirety.

### TECHNICAL FIELD

The present invention relates to a point cloud decoding device, a point cloud decoding method, and a program.

### BACKGROUND

Text of ISO/IEC 23090-9 DIS Geometry-based PCC w19088 and G-PCC codec description v6, ISO/IEC JTC1/SC29/WG11 w19091 disclose a technology for decoding 3D position (geometry) information of a point cloud compressed by octree division carried out recursively and a technology for decoding attribute information of points corresponding to a point-cloud position decoded according to needs.

Moreover, Spatial scalability support for G-PCC, ISO/IEC JTC1/SC29/WG11 m47352 discloses a scalable decoding technology for decoding point clouds, which are different in resolution, in a scalable manner by, as one function in Text of ISO/IEC 23090-9 DIS Geometry-based PCC w19088 and G-PCC codec description v6, ISO/IEC JTC1/SC29/WG11 w19091, decoding octree structures only up to an intermediate resolution as illustrated in FIG. 13.

By such a scalable decoding technology as described above, a point cloud with a low resolution can be decoded in a scalable manner without decoding all bit streams, and can be used for a thumbnail and the like.

### SUMMARY

In general, for example, when conceived is such an application as a viewer for viewing a point cloud generated by a free viewpoint video technology and the like, it becomes impossible to carry out real-time rendering on a terminal, which is poor in computer resource, if the number of input points is too large.

Accordingly, there is a case where, in order to carry out the real-time rendering, the number of decoded points is desired to be suppressed to a certain value or less by the scalable decoding function disclosed in Spatial scalability support for G-PCC, ISO/IEC JTC1/SC29/WG11 m47352.

However, the specifications described in Text of ISO/IEC 23090-9 DIS Geometry-based PCC w19088 have had a problem that the decoding cannot be carried out so as to suppress the number of points to a predetermined number or less since, at the time of carrying out the scalable decoding disclosed in Spatial scalability support for G-PCC, ISO/IEC JTC1/SC29/WG11 m47352, the number of points of an (n+1)-th layer in a descending order in the octree structure cannot be grasped until the (n+1)-th layer is decoded even if upper n layers therein can be decoded.

In this point, the number of points can be grasped if the (n+1)-th layer is decoded; however, there has been a problem that the decoding of the (n+1)-th layer is a heavy burden on the processing.

In this connection, the present invention has been made in consideration of the above-mentioned problems. It is an object of the present invention to provide a point cloud decoding device, a point cloud decoding method, and a program, which can carry out scalable decoding with a restricted number of output points so that the number of points becomes a designated number or less.

A first aspect of the present invention is summarized as a point cloud decoding device including: a geometry information decoding unit configured to decode numbers of points of respective layers of an octree structure.

A second aspect of the present invention is summarized as a point cloud decoding device including: a geometry information decoding unit configured to decode numbers of points of respective layers of an octree structure, wherein the geometry information decoding unit is configured to decode m (m is an integer greater than or equal to 1) defined as a syntax, and not to record the number of points or a number-of-points difference of initial m layers.

A third aspect of the present invention is summarized as a point cloud decoding device including: a tree synthesizing unit configured to carry out scalable decoding up to m (m is an integer greater than or equal to 1) layers below an input layer; and a LoD calculation unit configured to calculate a LoD (Level of Detail) based on attribute information of (m+1) layers.

A fourth aspect of the present invention is summarized as a point cloud decoding method including: decoding numbers of points of respective layers of an octree structure.

A fifth aspect of the present invention is summarized as a program for use in a point cloud decoding device, the program causing a computer to execute: decoding numbers of points of respective layers of an octree structure.

According to the present invention, it is possible to provide a point cloud decoding device, a point cloud decoding method, and a program, which can carry out scalable decoding with a restricted number of output points so that the number of points becomes a designated number or less.

### BRIEF DESCRIPTION OF DRAWINGS

FIG. 1 is a diagram illustrating an example of a configuration of a point cloud processing system 10 according to an embodiment.

FIG. 2 is a diagram illustrating a functional block of a point cloud decoding device 200 according to the embodiment.

FIG. 3 is an example of a configuration of encoded data (bit stream) received by geometry information decoding unit 2010 of the point cloud decoding device 200 according to the embodiment.

FIG. 4 is an example of a syntax configuration of GPS 2011 according to the embodiment.

FIG. 5 is an example of a syntax configuration of GPS 2012A/2012B according to the embodiment.

FIG. 6 is an example of the syntax configuration of GPS 2012A/2012B according to the embodiment.

FIG. 7 is a diagram for explaining control data decoded by the geometry information decoding unit 2010 of the point cloud decoding device 200 according to the embodiment.

FIG. 8 is a diagram for explaining the control data decoded by the geometry information decoding unit 2010 of the point cloud decoding device 200 according to the embodiment.

FIG. 9 is a diagram for explaining control data decoded by attribute information decoding unit 2060 of the point cloud decoding device 200 according to the embodiment.

FIG. 10 is an example of a syntax configuration of APS 2061 according to the embodiment.

FIG. 11 is a diagram for explaining an example of processing contents of a LoD calculation unit 2090 of the point cloud decoding device 200 according to the embodiment.

FIG. 12 is a diagram for explaining the example of the processing contents of the LoD calculation unit 2090 of the point cloud decoding device 200 according to the embodiment.

FIG. 13 is a diagram for explaining the related art.

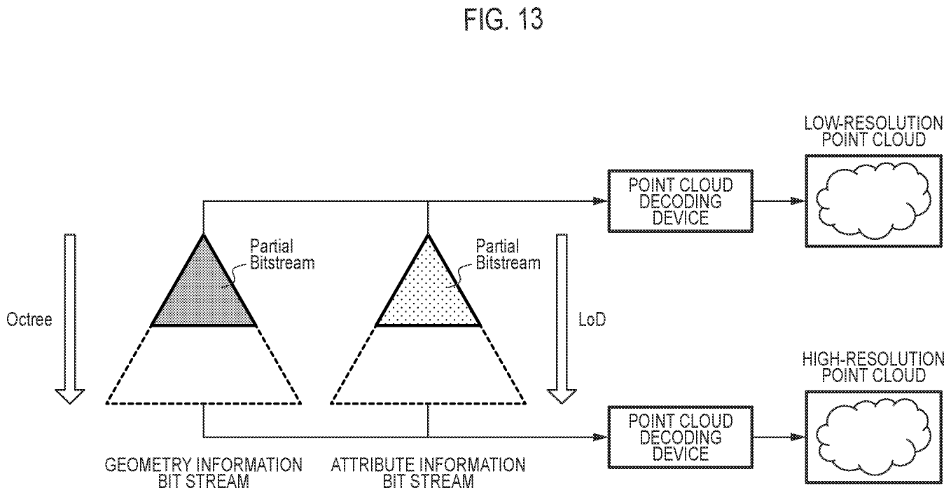

### DETAILED DESCRIPTION

An embodiment of the present invention will be explained hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### (First Embodiment)

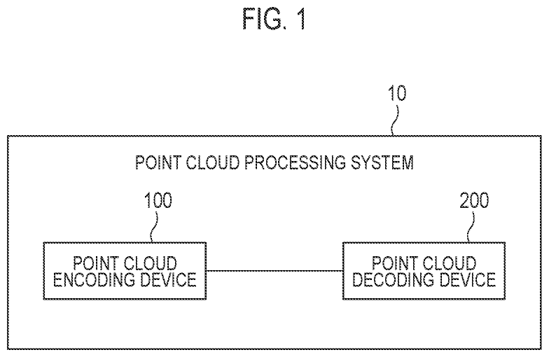

Hereinafter, with reference to FIG. 1 to FIG. 8, a point-cloud processing system 10 according to a first embodiment of the present invention will be described. FIG. 1 is a diagram illustrating the point-cloud processing system 10 according to an embodiment according to the present embodiment.

As illustrated in FIG. 1, the point-cloud processing system 10 has a point-cloud encoding device 100 and a point-cloud decoding device 200.

The point-cloud encoding device 100 is configured to generate encoded data (bit stream) by encoding input point-cloud signals. The point-cloud decoding device 200 is configured to generate output point-cloud signals by decoding the bit stream.

Note that the input point-cloud signals and the output point-cloud signals include position information and attribute information of points in point clouds. The attribute information is, for example, color information or a reflection ratio of each point.

Herein, the bit stream may be transmitted from the point-cloud encoding device 100 to the point-cloud decoding device 200 via a transmission path. The bit stream may be stored in a storage medium and then provided from the point-cloud encoding device 100 to the point-cloud decoding device 200.

### (Point-Cloud Decoding Device 200)

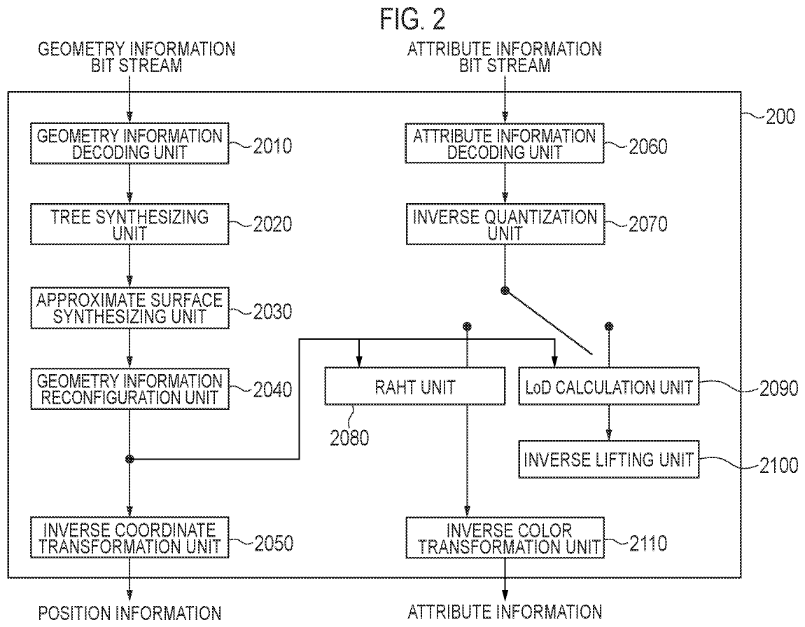

Hereinafter, with reference to FIG. 2, the point-cloud decoding device 200 according to the present embodiment will be described. FIG. 2 is a diagram illustrating an example of functional blocks of the point-cloud decoding device 200 according to the present embodiment.

The point cloud decoding device 200 has a function to receive a bit stream generated by the point cloud encoding device 100, and to decode position information and attribute information of the point cloud.

As illustrated in FIG. 2, the point-cloud decoding device 200 has a geometry information decoding unit 2010, a tree synthesizing unit 2020, an approximate-surface synthesizing unit 2030, a geometry information reconfiguration unit 2040, an inverse coordinate transformation unit 2050, an attribute-information decoding unit 2060, an inverse quantization unit 2070, a RAHT unit 2080, a LoD calculation unit 2090, an inverse lifting unit 2100, and an inverse color transformation unit 2110. Detailed functions of the respective units of a functional block diagram illustrated in FIG. 2 will be individually described.

The geometry information decoding unit 2010 is configured to use, as input, a bit stream about geometry information (geometry information bit stream) among bit streams output from the point-cloud encoding device 100 and to decode syntax.

A decoding process is, for example, a context-adaptive binary arithmetic decoding process. Herein, for example, the syntax includes control data (flags and parameters) for controlling the decoding process of the position information.

The tree synthesizing unit 2020 is configured to use, as input, control data, which has been decoded by the geometry information decoding unit 2010, and later-described occupancy code that shows on which nodes in a tree a point cloud is present and to generate tree information about in which regions in a decoding target space points are present.

The approximate-surface synthesizing unit 2030 is configured to generate approximate-surface information by using the tree information generated by the tree- information synthesizing unit 2020.

In a case where point clouds are densely distributed on a surface of an object, for example, when three-dimensional point-cloud data of the object is to be decoded, the approximate-surface information approximates and expresses the region in which the point clouds are present by a small flat surface instead of decoding the individual point clouds.

Specifically, the approximate-surface synthesizing unit 2030 can generate the approximate-surface information, for example, by a method called “Trisoup”. As specific processes of “Trisoup”, for example, the methods described in Text of ISO/IEC 23090-9 DIS Geometry-based PCC w19088 and G-PCC codec description v6, ISO/IEC JTC1/SC29/WG11 w19091 can be used. When sparse point-cloud data acquired by Lidar or the like is to be decoded, the present process can be omitted.

The geometry information reconfiguration unit 2040 is configured to reconfigure the geometry information of each point of the decoding-target point cloud (position information in a coordinate system assumed by the decoding process) based on the tree information generated by the tree-information synthesizing unit 2020 and the approximate-surface information generated by the approximate-surface synthesizing unit 2030.

The inverse coordinate transformation unit 2050 is configured to use the geometry information, which has been reconfigured by the geometry information reconfiguration unit 2040, as input, to transform the coordinate system assumed by the decoding process to a coordinate system of the output point-cloud signals, and to output the position information.

The attribute-information decoding unit 2060 is configured to use, as input, a bit stream about the attribute information (attribute-information bit stream) among bit streams output from the point-cloud encoding device 100 and to decode syntax.

A decoding process is, for example, a context-adaptive binary arithmetic decoding process. Herein, for example, the syntax includes control data (flags and parameters) for controlling the decoding process of the attribute information.

The attribute-information decoding unit 2060 is configured to decode quantized residual information from the decoded syntax.

The inverse quantization unit 2070 is configured to carry out an inverse quantization process and generate inverse-quantized residual information based on quantized residual information decoded by the attribute-information decoding unit 2060 and a quantization parameter which is part of the control data decoded by the attribute-information decoding unit 2060.

The inverse-quantized residual information is output to either one of the RAHT unit 2080 and LoD calculation unit 2090 depending on characteristics of the point cloud serving as a decoding target. The control data decoded by the attribute-information decoding unit 2060 specifies to which one the information is to be output.

The RAHT unit 2080 is configured to use, as input, the inverse-quantized residual information generated by the inverse-quantized residual information and the geometry information generated by the geometry information reconfiguration unit 2040 and to decode the attribute information of each point by using one type of Haar transformation (in a decoding process, inverse Haar transformation) called Region Adaptive Hierarchical Transform (RAHT). As specific processes of RAHT, for example, the methods described in Text of ISO/IEC 23090-9 DIS Geometry-based PCC w19088 and G-PCC codec description v6, ISO/IEC JTC1/SC29/WG11 w19091 can be used.

The LoD calculation unit 2090 is configured to use the geometry information, which has been generated by the geometry information reconfiguration unit 2040, as input and to generate Level of Detail (LoD).

LoD is the information for defining a reference relation (referencing point and point to be referenced) for realizing prediction encoding which predicts, from the attribute information of a certain point, the attribute information of another point and encodes or decodes prediction residual.

In other words, LoD is the information defining a hierarchical structure which categorizes the points included in the geometry information into plural levels and encodes or decodes the attributes of the point belonging to a lower level by using the attribute information of the point which belongs to a higher level.

As specific methods of determining LoD, for example, the methods described in Text of ISO/IEC 23090-9 DIS Geometry-based PCC w19088and G-PCC codec description v6, ISO/IEC JTC1/SC29/WG11 w19091 Text of ISO/IEC 23090-9 DIS Geometry-based PCC w19088 G-PCC codec description v6, ISO/IEC JTC1/SC29/WG11 w19091 may be used. Other examples will be described later.

The inverse lifting unit 2100 is configured to decode the attribute information of each point based on the hierarchical structure defined by LoD by using the LoD generated by the LoD calculation unit 2090 and the inverse-quantized residual information generated by the inverse-quantized residual information. As specific processes of the inverse lifting, for example, the methods described in Text of ISO/IEC 23090-9 DIS Geometry-based PCC w19088and G-PCC codec description v6, ISO/IEC JTC1/SC29/WG11 w19091 can be used.

The inverse color transformation unit 2110 is configured to subject the attribute information, which is output from the RAHT unit 2080 or the inverse lifting unit 2100, to an inverse color transformation process when the attribute information of the decoding target is color information and when color transformation has been carried out on the point-cloud encoding device 100 side. Whether to execute the inverse color transformation process or not is determined by the control data decoded by the attribute-information decoding unit 2060.

The point-cloud decoding device 200 is configured to decode and output the attribute information of each point in the point cloud by the above described processes.

Hereinafter, portions in the respective units of the point cloud decoding device 200, the portions being unique to the present invention, will be described.

(Geometry information Decoding Unit 2010)

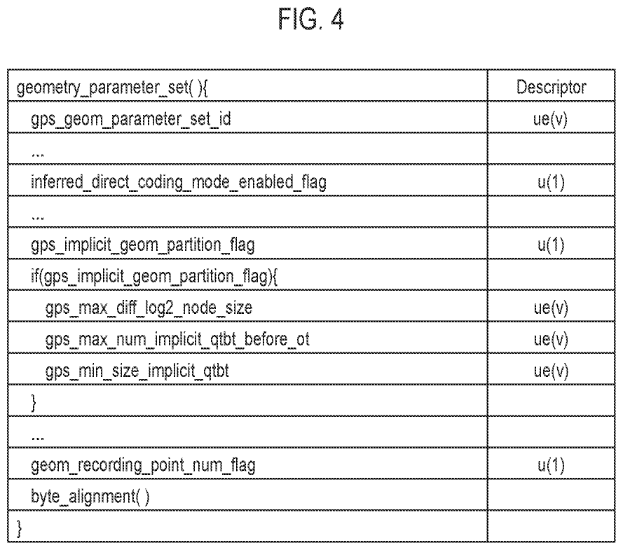

Hereinafter, the control data decoded by the geometry information decoding unit 2010 will be described by using FIG. 4 to FIG. 7.

FIG. 4 is a configuration example of the encoded data (bit stream) received by the geometry information decoding unit 2010.

First, the bit stream may include GPS 2011. The GPS 2011 is also called a geometry parameter set and is an aggregate of the control data about decoding of geometry information. A specific example will be described later. Each GPS 2011 includes at least GPS id information for individual identification in a case where plural pieces of GPS 2011 are present.

Secondly, the bit stream may include GSH 2012A/2012B. The GPS 2011 is an abbreviation for Geometry Parameter Set, which is a set of control data related to the decoding of geometric information. A specific example will be described later. The GSH 2012A/2012B includes at least GPS id information for specifying the GPS 2011 corresponding to the respective GSH 2012A/2012B.

Thirdly, the bit stream may include slice data 2013A/2013B subsequent to the GSH 2012A/2012B. The slice data 2013A/2013B includes encoded data of geometry information. An example of the slice data 2013A/2013B is later-described occupancy code.

As described above, the bit stream is configured so that the respective GSH 2012A/2012B and the GPS 2011 correspond to each slice data 2013A/2013B.

As described above, since which GPS 2011 is to be referenced is specified by the GPS id information in the GSH 2012A/2012B, the common GPS 2011 can be used for the plural pieces of slice data 2013A/2013B.

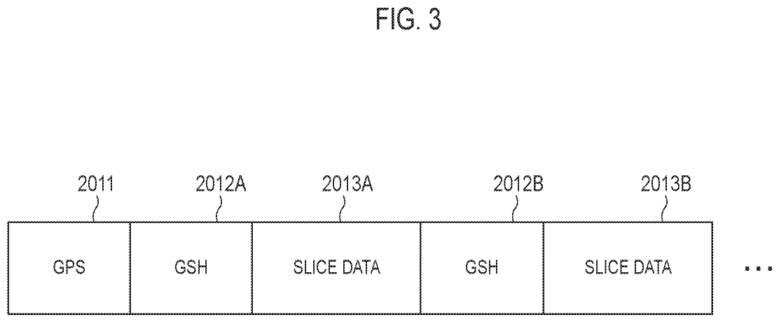

In other words, the GPS 2011 is not always required to be transmitted for each slice. For example, the bit stream can be configured so that the GPS 2011 is not encoded immediately anterior to the GSH 2012B and the slice data 2013B like FIG. 3.

Note that the configuration of FIG. 3 is merely an example. As long as the GSH 2012A/2012B and the GPS 2011 are configured to correspond to each slice data 2013A/2013B, an element(s) other than those described above may be added as a constituent element(s) of the bit stream. For example, the bit stream may include a sequence parameter set (SPS). Similarly, for transmission, the bit stream may be formed into a configuration different from that of FIG. 3. Furthermore, the bit stream may be synthesized with the bit stream, which is decoded by the later-described attribute-information decoding unit 2060, and transmitted as a single bit stream.

FIG. 4 is an example of a syntax configuration of the GPS 2011.

Note that syntax names in the following description are just exemplary. The syntax names may each vary as long as the corresponding function of syntax described below is achieved.

The GPS 2011 may include GPS id information (gps_geom_parameter_set_id) for identifying each GPS 2011.

The GPS 2011 may include a flag (inferred_direct coding_mode_enabled_flag) for controlling ON/OFF of an inferred direct coding mode (IDCM) to be described later by the tree synthesizing unit 2020.

Text of ISO/IEC 23090-9 DIS Geometry-based PCC w19088 and G-PCC codec description v6, ISO/IEC JTC1/SC29/WG11 w19091 disclose a method (implicitQtBt) of carrying out not the octree division but the quadtree division or the binary tree division, and the GPS 2011 may include a flag (gps_implicit_geom_partition_flag) representing whether or not to carry out the quadtree division or the binary tree division (QtBt) by the tree synthesizing unit 2020 on the basis of such a method as described in Text of ISO/IEC 23090-9 DIS Geometry-based PCC w19088 and G-PCC codec description v6, ISO/IEC JTC1/SC29/WG11 w19091.

For example, it may be defined that “QtBt” is carried out when the value of gps_implicit_geom_partition_flag is “1”, and it may be defined that only “Octree” is carried out when the value of gps_implicit_geom_partition_flag is “0”.

The GPS 2011 may include a flag (geom_recording_point_num_flag) which controls whether or not to record the number of points of each tier when a tree structure is decoded.

When the number of points as described above should not be reported, geom_recording_point_num_flag is turned OFF, thus making it possible not to record the number of points as described above. In general, the recording of the number of points as described above leads to an increase of a data size, and accordingly, ON/OFF of geom_recording_point_num_flag can be switched in accordance with a user's use.

Moreover, in consideration that the use case of the scalable decoding is present as a merit of reporting the number of points of each layer, Literature A “[New Proposal]On interaction between implicit QTBT and Scalable lifting (ISO/IEC JTC1/SC29/WG11 m53497)” makes a proposal that both of the scalable decoding and Implicit QtBt are made exclusive of each other since combinational use of both thereof causes a malfunction. Hence, when gps_implicit_geom_partition_flag is ON, geom_recording_point_num_flag may be turned OFF.

Note that a Descriptor section of FIG. 4 means a way how each syntax is encoded. An unsigned 0-exponent Golomb code is represented by ue(v), and a 1-bit flag is represented by u(l).

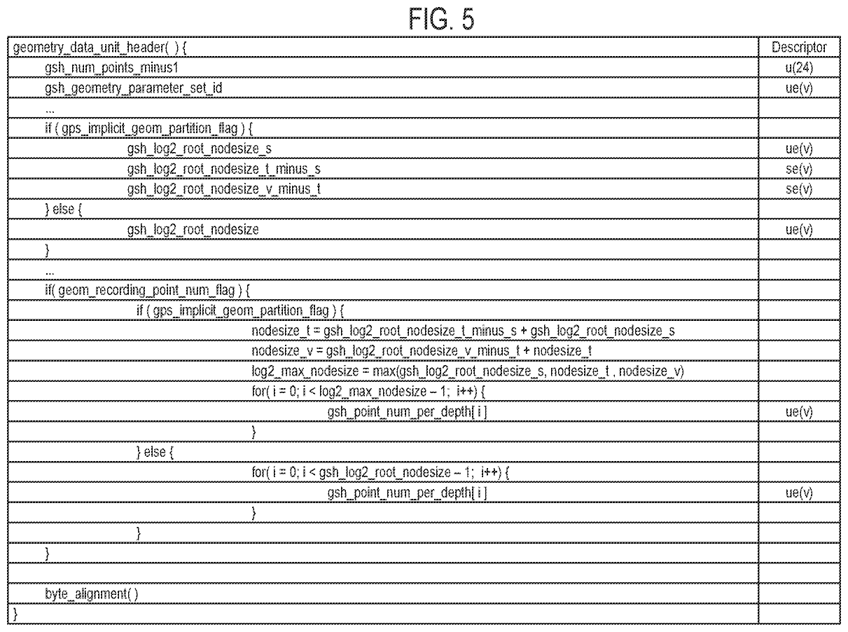

FIG. 5 is an example of the syntax configuration of the GSH 2012A/2012B.

The GSH 2012A/2012B may include a syntax (gsh_geometry_parameter_set_id) for specifying the GPS 2012 corresponding to the GSH 2012A/2012B.

The GSH 2012A/2012B may additionally include control data about ImplicitQtBt when the value of gps_implicit_geom_partition_flag is “1” (that is, at the time of “ON”) in the GPS 2012 corresponding to the GSH 2012A/2012B.

For example, the control data about ImplicitQtBt includes gsh_log2_root_nodesize_s, gsh_log2_root_nodesize_t_minus_s, gsh_log2_root_nodesize_v_minus_t, and the like, which are illustrated in FIG. 5.

Moreover, as illustrated in FIG. 5, the GSH 2012A/2012B may include a syntax (gsh_point_num_per_depth[i]) representing the number of points in each tier of the tree synthesized by the tree synthesizing unit 2020.

The value of gsh_point_num_per_depth[i] may be defined to be always a value of “0” or higher. For example, gsh_point_num_per_depth[i] may be encoded by the unsigned 0-exponent Golomb code, or may be encoded by the number of bits, which is specified in advance.

Moreover, since the number of nodes in the uppermost layer in the tree structure is one, and the number of points in the lowermost layer in the tree structure is calculated by a subtraction of “the sum of number of points in nodes other than in the lowermost layer” from “total number of points”, the number of points in the node in the uppermost layer and the number of points in the nodes in the lowermost layer may be defined to be able to be calculated, and without being included in gsh point_num_per_depth[i], may be calculated by the tree synthesizing unit 2020 after the geometry information is decoded.

Moreover, for the number of points in each tier in the tree structure, a difference value thereof from the number of points in the layer, which is stored therebefore, may be recorded. In this case, since such a difference value may sometimes be a negative value, the number of points may be recorded by a signed Golomb code se(v).

Moreover, from a viewpoint of reducing the amount of information, the number of points, which is recorded herein, may be not an accurate number of points but such a number of points, which is an approximate value. As a result, since it becomes unnecessary to record the accurate number of points, information on the number of points can be written with a small amount of information, and meanwhile, an error occurs from the actual number of points. Accordingly, it is possible that the recorded number of points may exceed a predetermined number of points from a viewpoint of “decoding the number of points so as to suppress the same within a predetermined range” to be described later.

Further, it is conceived that points with extremely low resolutions are less often used to be decoded. Therefore, when geom_recording_point_num_flag is ON (for example, when the value of geom_recording_point_num_flag is “1”), the geometry information decoding unit 2010 may skip the number of points of m layers from the uppermost layer without recording the number of points.

In this case, when geom_recording_point_num_flag is ON, the geometry information decoding unit 2010 may be configured to skip and not record the number of points (or a number-of-points difference) of initial m layers and record the number of points (or a number-of-points difference) of an m+1-th layer and after in gsh_point_num_per_depth[i] on the basis of m defined as a syntax.

For example, when m=5, the geometry information decoding unit 2010 may be configured not to record the number of points (or a number-of-points difference) of first to fifth layers in gsh_point_num_per_depth[i], and to record the number of points (or a number-of-points difference) of a sixth layer and after sequentially in gsh_point_num_per_depth[0] and after.

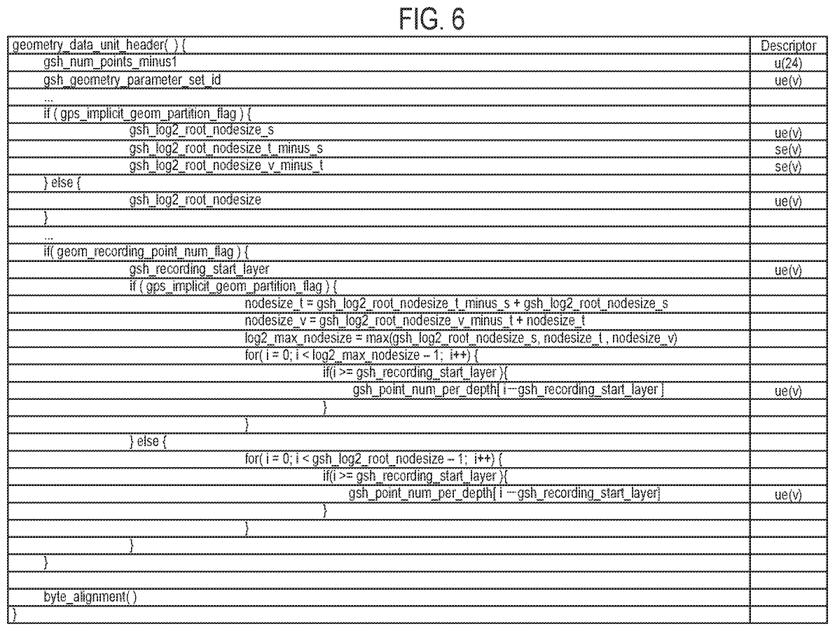

FIG. 6 illustrates an example of a syntax configuration in such a case. In FIG. 6, m is recorded as a syntax of which name is gsh_recording_start_layer.

In the example of FIG. 6, gsh_recording_start_layer is represented by an unsigned 0-exponent Golomb code, but may be recorded as a descriptor with an s-bit fixed length in consideration that it is not conceived that the number of layers increases extremely.

Note that a portion in which the number of points in such respective tiers is recorded does not always need to be the GSH 2012A/2012B, and for example, the number of points in such respective tiers may be recorded in the GPS 2011 if the slice is secured to be one.

In the case of the scalable decoding, the respective tiers in the LoD structure formed by the LoD calculation unit 2090 and the octree structure coincide with each other, and accordingly, the number of points in such respective tiers may be recorded as the number of points in the LoD Structure in an attribute slice header (ASH) to be described later or the APS.

### (Tree Synthesizing Unit 2020)

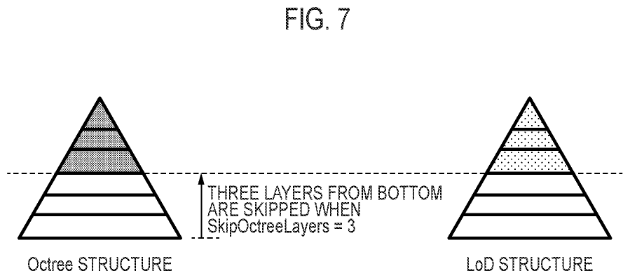

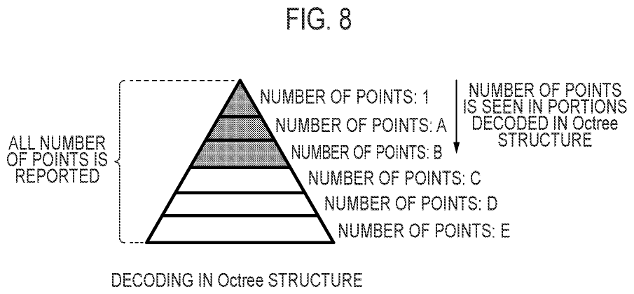

Referring to FIGS. 7 and 8, control data decoded by the geometry information decoding unit 2010 will be described.

The tree synthesizing unit 2020 is configured to acquire positions of the points, which represent in which region in a decoding target space the points are present, by decoding a tree structure to be described later by receiving the control data decoded by the geometry information decoding unit 2010 and an occupancy code that represents on which nodes in the tree structure the point cloud is present.

The tree synthesizing unit 2020 is configured to acquire the positions of such points by defining the decoding target space as a cube and recursively repeating division of the cube into 2×2×2 finer cuboids. At this time, the tree synthesizing unit 2020 refers to an 8-bit occupancy code for one node, thereby sequentially calculating on which 2×2×2 regions the nodes are formed.

Herein, as illustrated in FIG. 15, at the time of carrying out the scalable decoding function, a parameter (SkipOctreeLayers) that represents how many layers are to be skipped from the bottom of the octree structure is given from the outside of the point cloud decoding device 200 in accordance with Text of ISO/IEC 23090-9 DIS Geometry-based PCC w19088. As illustrated in FIG. 7, how many layers from the top are to be decoded are determined on the basis of SkipOctreeLayers.

Thus, a resolution of the point cloud decoded by the point cloud decoding device 20 on the basis of SkipOctreeLayers can be determined in a scalable manner; however, as in FIG. 8, the number of points at the time of decoding up to the next layer (the number of points C in FIG. 8) cannot be grasped.

Hence, for example, when it is desired that the processing be stopped so that the number of decoded point clouds becomes S pieces or less and that the scalable decoding be carried out, if the number of points is T (T<S) at the point of time when “number of points 1+number of points A+number of points B” in FIG. 8, unless the layer of the number of points C is decoded, it cannot be determined whether the number of point clouds does not exceed the point S even if the decoding is carried out while the layer of the number of points C is being included or the number of point clouds exceeds the point S when the layer of the number of points C is included.

However, when the layer of the number of points C is decoded, a waste of calculation resources is generated equivalently.

Hence, in the present embodiment, the geometry information decoding unit 2010 grasps the number of points in the next layer before decoding the next layer by reporting the number of points in each layer, and can thereby carry out the decoding processing so as to suppress the same within a range of the point S or less without decoding the layer of the number of points C. This is not limited to setting the number of points of a point cloud as a threshold value, but in terms of consideration, can also apply to the case of specifying a ratio, for example, the case of carrying out the decoding while suppressing a decoding ratio to be less than 50% of all the number of points.

At the time of carrying out the decoding of such an octree structure, direct coding mode (DCM) is introduced in the technologies described Text of ISO/IEC 23090-9 DIS Geometry-based PCC w19088 and G-PCC codec description v6, ISO/IEC JTC1/SC29/WG11 w19091. DCM is a tool for enhancing compression efficiency by, when the number of nodes linked with a certain node is as small as one or two, directly encoding positions where points are present and decoding the same by the point cloud decoding device 200 without describing the occupancy code. In particular, in Text of ISO/IEC 23090-9 DIS Geometry-based PCC w19088 and G-PCC codec description v6, ISO/IEC JTC1/SC29/WG11 w19091, inferred DCM (IDCM) for determining whether or not to carry out DCM implicitly from surrounding nodes.

### (Attribute Information Decoding Unit 2060)

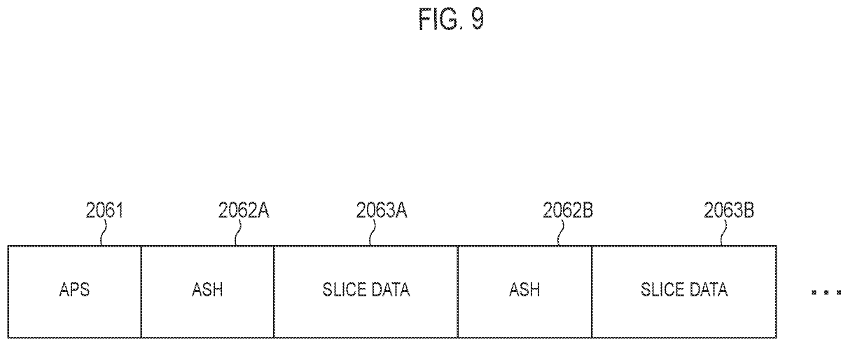

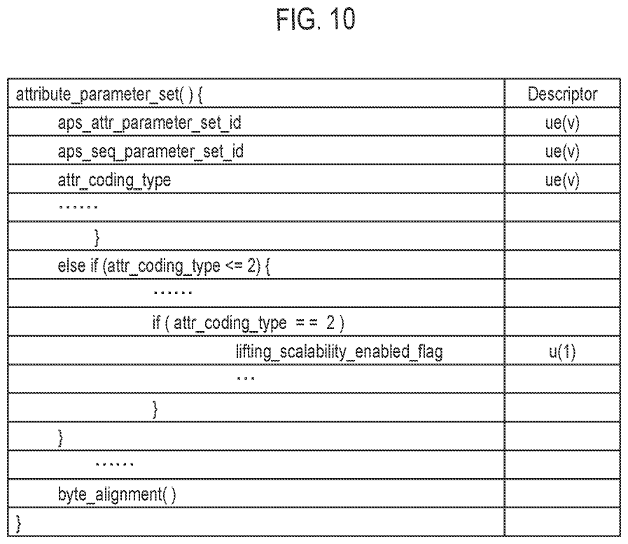

Hereinafter, referring to FIGS. 9 and 10, control data decoded by the attribute information decoding unit 2060 will be described.

FIG. 9 is an example of a configuration of encoded data (bit stream) received by the attribute information decoding unit 2060.

First, the bit stream may include APS 2061. The APS 2061 is an abbreviation of “Attribute Parameter Set” and is an aggregate of the control data about decoding of attribute information. A specific example will be described later.

As the attribute information, conceived are information on reflectance of the point cloud, and the like as well as color information of the point cloud, and a plurality of the APS 2061 may be prepared for each attribute type. Each APS 2061 includes at least APS id information for identifying each of the plurality of APS 2061 when the plurality of APS 2061 is present.

Secondly, the bit stream may include ASH 2062A/2062B. The ASH 2062A/2062B are an abbreviation of “Attribute Slice Header”, and has control data corresponding to each slice. A specific example will be described later. The ASH 2062A/2062B include at least APS id information for specifying the APS 2061 corresponding to the respective ASH 2062A/2062B.

Thirdly, the bit stream may include slice data 2063A/2063B subsequent to the ASH 2062A/2062B. The slice data 2063A/2063B include encoded data of the attribute information.

As described above, the bit stream is configured so that the respective ASH 2062A/2062B and the APS 2061 correspond to the respective slice data 2063A/2063B one by one.

As mentioned above, since which APS 2061 is to be referenced is specified by the APS id information in the ASH 2062A/2062B, the common APS 2061 can be used for the plural pieces of slice data 2063A/2063B.

Note that the configuration of FIG. 9 is merely an example. If the ASH 2062A/2062B and the APS 2061 are configured to correspond to each slice data 2063A/2063B, an element(s) other than those mentioned above may be added as a constituent element(s) of the bit stream. For example, the bit stream may include a sequence parameter set (SPS).

Moreover, similarly, for transmission, the bit stream may be formed into a configuration different from that of FIG. 9. Furthermore, the bit stream may be synthesized with the bit stream, which is decoded by the above-described geometry information decoding unit 2010, and may be transmitted as a single bit stream. For example, the bit stream may be configured so that each of the slice data 2013A and 2063A and the slice data 2013B and 2063B is treated as single slice data, and that the GSH 2012A and the ASH 2062A or the GSH 2012B and the ASH 2062B is disposed immediately anterior to each slice. Moreover, in such a case, the GPS 2011 and the APS 2061 may be disposed before each of the GSH and the ASH.

FIG. 10 is an example of the syntax configuration of the APS 2061.

The APS 2061 may include APS id information (aps_attr_parameter_set_id) for identifying each APS 2061.

The APS 2061 may include information (attr_coding_type) which represents a decoding method of the attribute information. For example, it may be defined that: when the value of attr_coding_type is “0”, variable weighted lifting prediction is carried out by the inverse lifting unit 2100; when the value of attr_coding_type is “1”, RAHT is carried out by the RAHT unit 2080; and, when the value of attr_coding_type is “2”, lifting prediction with a fixed weight is carried out by the inverse lifting unit 2100.

The APS 2061 may include a flag (lifting scalability enabled flag) which represents whether the scalable lifting (a lifting method at the time of scalable decoding, which is disclosed in Spatial scalability support for G-PCC, ISO/IEC JTC1/SC29/WG11 m47352) is to be applied or not when the value of attr_coding_type is “2”, in other words, when the lifting prediction with the fixed weight is to be carried out by the inverse lifting unit 2100.

In the present embodiment, it is defined that the scalable lifting is not carried out when lifting scalability enabled flag is “0”, and that the scalable lifting is carried out when lifting_scalability_enabled_flag is “1”.

In the present embodiment, an object to define, as a syntax, the number of points of each layer in the octree structure is to grasp the number of points in the undecoded n+1-th layer when this scalable decoding is carried out. From this, it may be defined that geom_recording_point_num_flag is always set to “0” when the scalable lifting is not used (when lifting_scalability_enabled_flag=0). (LoD calculation unit 2090)

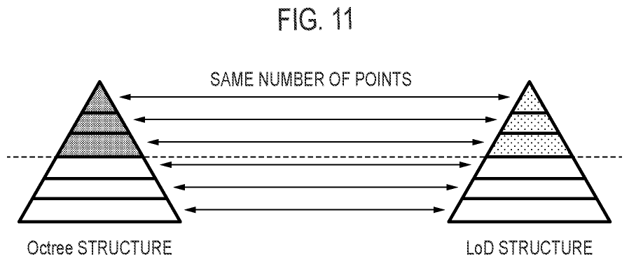

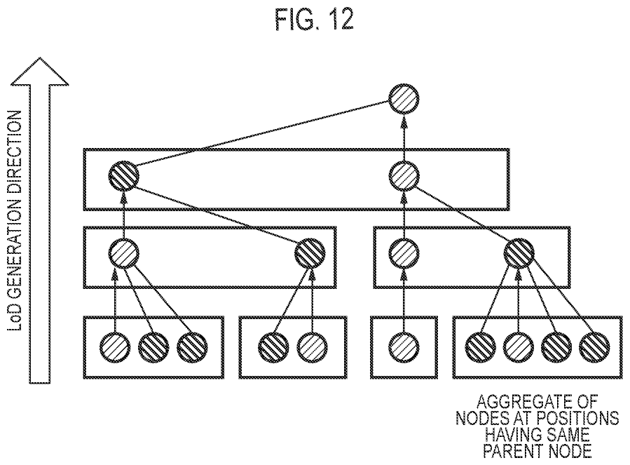

Hereinafter, referring to FIGS. 11 and 12, an example of processing contents of the LoD calculation unit 2090 will be described.

The LoD calculation unit 2090 is configured to receive geometry information generated by the geometry information reconfiguration unit 2040, and to generate an LoD.

A generation method of the LoD structure is mentioned in Text of ISO/IEC 23090-9 DIS Geometry-based PCC w19088 and G-PCC codec description v6, ISO/IEC JTC1/SC29/WG11 w19091, and in the case of carrying out the scalable decoding illustrated in FIG. 15, it is necessary to cause the number of points of each layer in the LoD structure to coincide with the number of points of each layer in the octree structure. This is in order to cause the number of points in the geometry (octree) structure and the number of points in the attribute (LoD) structure to coincide with each other to whichever layer the skip may be made as in FIG. 11 at the time of carrying out the scalable decoding.

In order to achieve such coincidence of the number of points between the octree structure and the LoD structure, the LoD calculation unit 2090 is configured to generate LoD, which is based on the octree structure, in the scalable lifting.

For reference, a generation method of the LoD structure at the time of encoding will be described. Specifically, as illustrated in FIG. 12, the point cloud obtained by the geometry information reconfiguration unit 2040 is disposed on the lowermost layer in the LoD structure (“lower” herein is a direction where points are dense/a downward direction of a pyramid), nodes at a position of having the same parent node are treated as one aggregate, and one point among them is selected as a representative that is an upper-layer LoD.

Unselected points are left in that layer. By repeating this operation, the number of points selected to the upper layer coincides with the number of points in a layer of the octree structure, which has the same depth.

In the case of carrying out the scalable decoding, the point cloud decoding device 200 generates the LoD sequentially from an intermediate layer toward an upper portion in FIG. 12. Although a quantization error occurs about the position, it is possible to construct the LoD structure itself, in which the LoD is constructed by selecting points to be raised to the upper level, in the same way also in the case of carrying out the decoding from the intermediate layer.

At the time of forming such a LoD structure, as a method of selecting the points to be raised to the upper level, a method of selecting points with the smallest/largest Morton codes on the basis of an order of the Morton codes may be adopted as in Text of ISO/IEC 23090-9 DIS Geometry-based PCC w19088 and G-PCC codec description v6, ISO/IEC JTC1/SC29/WG11 w19091 G-PCC codec description v6, ISO/IEC JTC1/SC29/WG11 w19091. Alternatively, as shown in Literature B “[G-PCC]CE13.15 report on LoD generation with distance from centroid for spatial scalability(ISO/IEC JTC1/SC29/WG11 m53288)”, a method of calculating the center of gravity in a group that belongs to the same parent node and selecting a point closest to the center of gravity may be adopted.

Moreover, when the points are two, and so on at the time of generating the LoD on the basis of the position of the center of gravity as mentioned above, there is a problem that the position of the center of gravity is always located at an intermediate between the points, resulting in difficulty selecting the point close to the center of gravity. In such a case, it is possible to select either one in accordance with the order of the Morton codes, and the like; however, it is not always possible to select the optimal point.

Accordingly, at the time of carrying out the scalable decoding, the tree synthesizing unit 2020 carries out the decoding to a layer deeper by one step than the layer specified by the SkipOctreeLayers. When the center of gravity is located at the intermediate position, then on the basis of the number of points linked with those in a layer lower by one layer of the respective points, the tree synthesizing unit 2020 selects the larger number of points as the LoD. As described above, the generation of the LoD may be refined.

Moreover, there may be adopted: a method of selecting a point closest to a position of the center of gravity of a point located in a layer lower by two layers; and a method of selecting a node closest to positions of the center of gravity, which are calculated by weighting a position of the center of gravity in a layer lower by one layer and the position of the center of gravity in the layer lower by two layers. Further, the tree synthesizing unit 2020 may decode not only the layer lower by one layer but also layers lower by m layers, and may refine the LoD on the basis of geometry information thereof.

Further, the point-cloud encoding device 100 and the point-cloud decoding device 200 may be realized as a program causing a computer to execute each function (each step).

Note that the above described embodiments have been described by taking application of the present invention to the point-cloud encoding device 10 and the point-cloud decoding device 30 as examples. However, the present invention is not limited only thereto, but can be similarly applied to an encoding/decoding system having functions of the encoding device 10 and the decoding device 30.

What is claimed is:

1. A point cloud decoding device comprising:
a geometry information decoding unit configured to decode numbers of points of respective layers of an octree structure.

2. The point cloud decoding device according to claim 1, wherein
the geometry information decoding unit is configured not to decode a number of points of an uppermost layer and a number of points of a lowermost layer among the numbers of points of the respective layers.

3. The point cloud decoding device according to claim 2, wherein
the number of points of the uppermost layer is 1.

4. The point cloud decoding device according to claim 1, further comprising a tree synthesizing unit configured to determine a number of layers, which are subjected to scalable decoding, on the basis of the number of points so that a maximum number of output points given as an input parameter is not exceeded.

5. The point cloud decoding device according to claim 1, further comprising a tree synthesizing unit configured to determine a number of layers, which are subjected to scalable decoding, on the basis of the number of points so that a ratio given as an input parameter is not exceeded.

6. A point cloud decoding method comprising:
decoding numbers of points of respective layers of an octree structure.

7. A program for use in a point cloud decoding device, the program causing a computer to execute:
decoding numbers of points of respective layers of an octree structure.
